(19) United States
(12) Patent Application Publication
(10) Pub. No.: US 2001/0001962 A1
(43) Pub. Date: May 31, 2001

(54) FLUID FLOW DETECTION SYSTEM EMPLOYING SAMPLING TECHNIQUE

(75) Inventor: JOSEPH J. WEISHEW, ORELAND, PA (US)

Correspondence Address: THE LANGSTON CORPORATION, 111 WOODCREST ROAD, CHERRY HILL, NJ, 08034, US

(73) Assignee: Gregory J. Lavorgna

(21) Appl. No.: 09/292,425

(22) Filed: Apr. 15, 1999

(51) Int. Cl. F16K 31/02

(52) U.S. Cl. 137/392

(57) ABSTRACT

An apparatus and system for monitoring liquid flow and detecting low flow conditions. The apparatus includes a liquid collection reservoir having a cavity, an inlet through which liquid enters the reservoir cavity, and an outlet through which the liquid drains from the cavity. A first flow restrictor upstream of the inlet is selectably openable and closeable to regulate flow of the liquid into the cavity, and a second flow restrictor downstream of the outlet is selectably openable and closeable to regulate flow of the liquid from the cavity. A controller controls the state of the flow restrictors to alternately open the first flow restrictor and simultaneously close the second flow restrictor for a first period of time to allow fluid to enter and remain in the cavity, and then close the first flow restrictor and simultaneously open the second flow restrictor for a second period of time to prevent fluid from entering the cavity and allow fluid to drain from the cavity. A sensor operatively associated with the cavity senses whether liquid in the cavity reaches a preselected level during the first period of time.

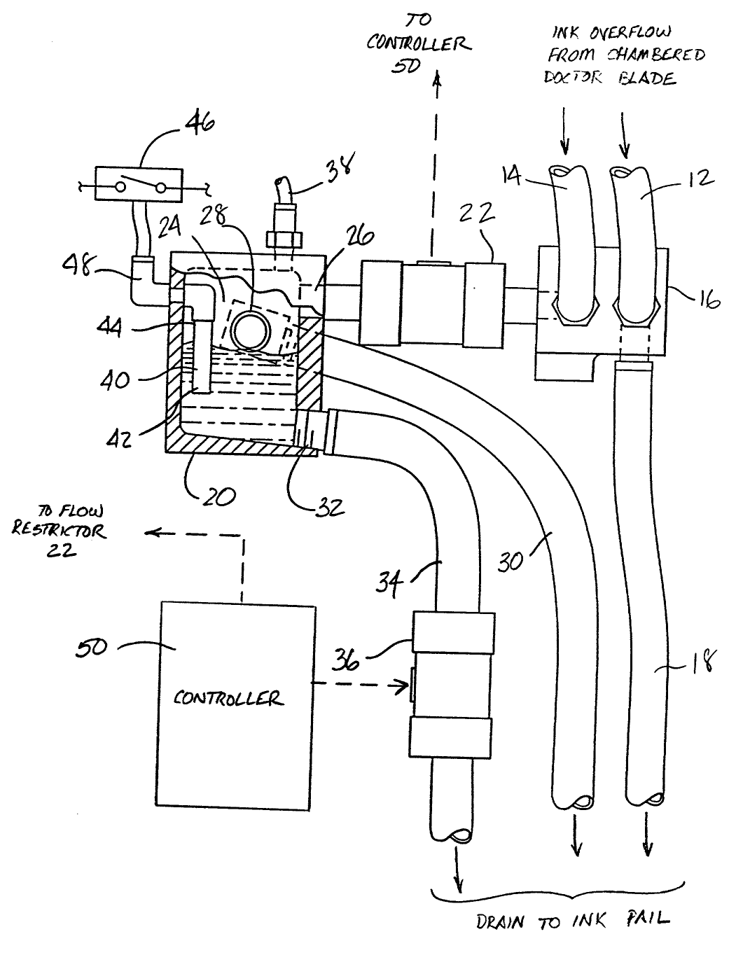

### FIELD OF THE INVENTION

The present invention is directed to an apparatus and system for monitoring fluid flow and detecting low flow conditions. In particular, the invention is directed to an apparatus and system for monitoring the flow of printing ink in a chambered doctor blade ink fountain in a flexographic printing press.

### BACKGROUND OF THE INVENTION

Various devices detect, monitor and/or control the levels of liquids. However, when the liquids whose levels are being detected, monitored and/or controlled are viscous (e.g., printing inks), problems are often encountered. For example, level monitoring devices for viscous liquids are generally quite complex. In addition, it is often difficult to easily and efficiently clean these complex devices; thus, increasing the possibility of false readings.

Notwithstanding the above, there are many different industries wherein it is critical to monitor the supply and/or level of viscous liquid. One example of an industry where liquid levels play a vital role is the printing industry.

In the printing industry, printing ink (a relatively viscous liquid) is often applied to a stencil (e.g., an impression cylinder). While there are many different ways in which to apply ink to such stencils, one of the more common approaches is to employ an ink distribution system. For example, a metering roll (e.g., an Anilox metering roll), which directly or indirectly comes into contact with an ink supply, is often used.

Flexography is one specific type of a printing process which often employs the use of metering rolls. In flexographic printing processes, ink is generally pumped form an ink source into an ink fountain or well until the level of ink reaches a predetermined full position.

As the metering roll rotates, it picks up ink from the fill fountain. A doctor blade assembly is then often employed to control the amount of ink adhering to the outer surface of the metering roll.

Since ink is continually being picked up by the metering roll and ultimately distributed to the surface being printed, it is necessary to have a constant supply of ink to the fountain in order to maintain the “full” position. Maintaining a “full” position is often critical since, in many instances, if the ink level within the fountain falls below that predetermined full position, the particular printing process will be adversely affected. Accordingly, under these circumstances it is necessary to employ some sort of ink level detecting system. However, as stated above, most liquid level detecting devices are not adequate for measuring the level of viscous liquids, such as printing inks. Moreover, those which do exist, are generally quite complex, require a steady flow of ink into an ink overflow reservoir, and are difficult to clean. An operator must continuously monitor the flow of ink and make adjustments to the flow rate to be certain there is a sufficient ink level in the ink overflow reservoir to assure proper detection. In addition, the continuous operation of such devices generally requires a flow restriction (such as a valve) in order to keep a sufficient ink level in the ink overflow reservoir. The restriction can become clogged, which makes it difficult to clean such devices.

In view of the above, the printing industry would greatly welcome an improved, yet simplified, method for detecting, monitoring and/or controlling the level of viscous liquids such as printing inks. Such a device would also be greatly welcomed by other industries where it is necessary to detect, monitor and/or control the level of viscous liquids.

### SUMMARY OF THE INVENTION

In its broad aspects, the present invention is directed to an apparatus and system for monitoring liquid flow and detecting low flow conditions. The apparatus includes a liquid collection reservoir having a cavity, an inlet through which liquid enters the reservoir cavity, and an outlet through which the liquid drains from the cavity. A first flow restrictor upstream of the inlet is selectably openable and closeable to regulate flow of the liquid into the cavity, and a second flow restrictor downstream of the outlet is selectably openable and closeable to regulate flow of the liquid from the cavity. A controller controls the state of the flow restrictors to alternately open the first flow restrictor and simultaneously close the second flow restrictor for a first period of time to allow fluid to enter and remain in the cavity, and then close the first flow restrictor and simultaneously open the second flow restrictor for a second period of time to prevent fluid from entering the cavity and allow fluid to drain from the cavity. A sensor operatively associated with the cavity senses whether liquid in the cavity reaches a preselected level during the first period of time.

### BRIEF DESCRIPTION OF THE DRAWING

For the purpose of illustrating the invention, there is shown in the drawing a form which is presently preferred; it being understood, however, that this invention is not limited to the precise arrangements and instrumentalities shown.

The sole FIGURE illustrates in simplified form an apparatus and system for monitoring fluid flow and detecting low flow conditions according to the present invention.

### DESCRIPTION OF THE INVENTION

Referring to the drawing, there is shown an apparatus and system 10 for monitoring fluid flow and detecting low flow and low level conditions according to the present invention, in the context of an ink flow detector for printing ink in a flexographic printing press. In particular, the flexographic printing press uses a chambered doctor blade ink fountain, not shown but known per se in the art, which has a chamber into which ink is continuously supplied for printing and from which ink overflows by gravity back into the ink supply pail. As long as proper ink flow to the chamber is maintained, ink will overflow back to the ink supply pail. Thus, the presence of ink overflow will indicate proper ink supply to and ink level in the chamber. On the other hand, an absence of overflow will indicate an insufficient ink supply to or low ink level in the chamber.

Ink overflowing from the doctor blade flows from the chamber through overflow lines 12 and 14 into a manifold block 16. Manifold block 16 allows some of the ink to drain directly into the ink pail (not shown, but known per se) through drain line 18. Manifold block 16 also directs some of the ink overflowing from the chamber into a reservoir 20 though a flow restrictor 22, which may be, for example, an electrically actuated pinch valve or other remotely actuated electric, hydraulic, or pneumatic valve.

As can be seen in the drawing, reservoir 20 defines an interior cavity 24 for holding a quantity of ink. Reservoir 20 includes an inlet 26 which is in fluid communication with flow restrictor 22 and through which ink enters reservoir 20. Reservoir 20 also includes an overflow opening 28 located in one wall of reservoir 20. Overflow opening 28 is in fluid communication with drain line 30, which allows excess ink in cavity 24 to drain directly into the ink pail. The location of overflow opening 28 relative to the bottom of reservoir 20 establishes a normal operating ink level, which will be discussed in more detail below. Reservoir 20 further includes an outlet 32 through which ink drains from cavity 24 through drain line 34. Drain line 34 is provided with a second flow restrictor 36 downstream of outlet 32. Flow restrictor 36 may, like flow restrictor 22 be an electrically actuated pinch valve or other remotely actuated electric, hydraulic, or pneumatic valve. Reservoir 20 also is equipped with an air vent 38 in the top wall of reservoir 20, to permit the escape of air displaced by ink flowing into cavity 24 through inlet 26.

A hollow air sensor tube 40 is disposed in cavity 24, and has a lower end 42 which is open and an upper end 44 which is in fluid communication with a pressure switch 46 via suitable fittings 48. Preferably, pressure switch 46 is located external to reservoir 20, but it may be located wherever convenient. Lower end 42 of sensor tube 40 is located so that it is below the normal operating ink level established by overflow opening 28.

A controller 50 is operatively connected to flow restrictors 22 and 36, and provides actuating signals (either electrical, hydraulic, or pneumatic, as may be desired) to flow restrictors 22 and 36, to open or close flow restrictors 22 and 36 and thus control the flow of ink through them. Any suitable controller, such as a programmable logic controller, can be used, and the manner in which controller 50 can be programmed to perform its intended functions will be apparent to those skilled in the art.

In operation, ink overflowing from the chamber drains through drain lines 12 and 14. Initially, controller 50 sends an actuating signal to flow restrictor 22 to cause flow restrictor 22 to be in an open state and sends an actuating signal to flow restrictor 36 to cause flow restrictor 36 to be in a closed state. Thus, ink flowing through drain line 14 is directed through flow restrictor 22 and inlet 26 into cavity 24, and remains there. As ink continues to enter cavity 24, its level rises until it reaches the normal operating ink level established by overflow opening 28. As the ink level rises, air in air sensor tube 40 is slightly compressed by the rising ink, causing an increase in air pressure inside air sensor tube. This increase in air pressure actuates pressure switch 46, causing it to close. Closure of pressure switch 46 may be used to complete an electrical circuit and thus provide an indication of proper ink level in reservoir 20.

After a desired interval, controller 50 signals flow restrictor 22 to close and flow restrictor 36 to open, which allows the ink in reservoir 20 to drain through outlet 32, thus emptying cavity 24 of ink and preparing cavity 24 for a subsequent filling cycle. After a second desired interval, controller 50 signals flow restrictor 22 to open and flow restrictor 36 to close, allowing a subsequent filling cycle to begin.

With the present invention, there is no need for operator monitoring or adjustment after an initial set-up. The operator need not continuously monitor the level of ink in the reservoir 20 and adjust the flow rate to maintain a proper ink lever. This eliminates potential operator error and leads to more reliable operation. In addition, since the flow restrictors 22 and 36 are either open or closed, and not in an intermediate state as would be necessary in a non-sampling device, there is less danger of clogging, and they are consequently easier to keep clean.

The present invention may be embodied in other specific forms without departing from the spirit or essential attributes thereof and, accordingly, reference should be made to the appended claims, rather than to the foregoing specification, as indicating the scope of the invention.

1. An apparatus and system for monitoring liquid flow and detecting low flow conditions, comprising
a. a liquid collection reservoir having a cavity, an inlet through which liquid enters the reservoir cavity, and an outlet through which the liquid drains from the cavity,
b. a first flow restrictor upstream of the inlet, the first flow restrictor being selectably openable and closeable to regulate flow of the liquid into the cavity,
c. a second flow restrictor downstream of the outlet, the second flow restrictor being selectably openable and closeable to regulate flow of the liquid from the cavity,
d. a controller for controlling the state of the flow restrictors to alternately open the first flow restrictor and simultaneously close the second flow restrictor for a first period of time to allow fluid to enter and remain in the cavity, and then close the first flow restrictor and simultaneously open the second flow restrictor for a second period of time to prevent fluid from entering the cavity and allow fluid to drain from the cavity, and
e. a sensor operatively associated with the cavity and arranged to sense whether liquid in the cavity reaches a preselected level during the first period of time.

2. An apparatus and system according to claim 1, wherein the first and second flow restrictors are remotely actuated valves.

3. An apparatus and system according to claim 2, wherein the remotely actuated valves are selected from the group comprising electrically actuated valves, hydraulically actuated valves, and pneumatically actuated valves.

4. An apparatus and system according to claim 1, wherein the sensor comprises a hollow tube having a first end for immersion in the fluid in the reservoir cavity and a second end in communication with a pressure switch.

5. An apparatus and system according to claim 4, wherein the hollow tube first end is located so that it is below the preselected level.

6. An ink flow monitoring and detecting system for a printing apparatus, comprising
a. a collection reservoir having a cavity, an inlet through which ink enters the reservoir cavity, and an outlet through which the ink drains from the cavity,
b. a first selectably openable and closeable valve to regulate flow of the ink into the cavity,
c. a second selectably openable and closeable valve to regulate flow of the ink from the cavity,
d. a controller for controlling the state of the first and second valves to alternately open the first valve and simultaneously close the second valve for a first period of time to allow ink to enter and remain in the cavity, and then close the first valve and simultaneously open the second valve for a second period of time to prevent ink from entering the cavity and allow ink to drain from the cavity, and
e. a level detector in the cavity to sense whether the ink in the cavity reaches a preselected level during the first period of time.

7. An apparatus and system according to claim 6, wherein the first and second valves are selected from the group comprising electrically actuated valves, hydraulically actuated valves, and pneumatically actuated valves.

8. An apparatus and system according to claim 6, wherein the sensor comprises a hollow tube having a first end for immersion in the ink in the reservoir cavity and a second end in communication with a pressure switch, the hollow tube first end being located so that it is below the preselected ink level.

9. An ink flow monitoring and detecting system for a printing apparatus, comprising
a. a collection reservoir having a cavity, an inlet through which ink enters the reservoir cavity, and an outlet through which the ink drains from the cavity,
b. a first remotely operable valve having an open position and a closed position to regulate flow of the ink into the cavity,
c. a second remotely operable valve having an open position and a closed position to regulate flow of the from the cavity,
d. a controller for alternately actuating the first valve to place it in the open position and simultaneously actuating the second valve to place it in the closed position for a first period of time to allow ink to enter and remain in the cavity, and then actuating the first valve to place it in the closed position and simultaneously actuating the second valve to place it in the open position for a second period of time to prevent ink from entering the cavity and allow ink to drain from the cavity,
e. a hollow tube having a first end located so that it is below the preselected ink level in the reservoir and a second end extending out of the cavity, and
f. a pressure switch in communication with the hollow tube second end for generating an electrical open or short circuit in response to ink level in the reservoir.

10. A method for monitoring liquid flow and detecting low flow conditions, comprising the steps of
a. allowing a portion of liquid to flow into a collector for a first period of time,
b. establishing a normal operating liquid level in the collector,
c. sensing whether liquid flowing into the collector reaches the normal operating liquid level before the first period of time expires,
d. after the first period of time expires, preventing liquid from flowing into the collector and draining liquid then in the collector to substantially empty the collector, and
e. repeating steps a. through d. as desired.
